(19) United States
(12) Patent Application Publication
(10) Pub. No.: US 2022/0156860 A1
(43) Pub. Date: May 19, 2022

(54) System and Method of Optimizing a Lead Conversion Rate for a Real Estate Agent

(71) Applicant: Hommati Franchise Network, Inc., Westerville, OH (US)

(72) Inventor: Jerry L. Clum, JR., Westerville, OH (US)

(21) Appl. No.: 17/526,485

(22) Filed: Nov. 15, 2021

Related U.S. Application Data
(60) Provisional application No. 63/113,525, filed on Nov. 13, 2020.

(51) Int. Cl. G06Q 50/16

(52) U.S. Cl. CPC G06Q 50/16

(57) ABSTRACT

A method and system of optimizing a lead conversion rate for a real estate agent is used by a real estate agent to secure a higher number of listings by reducing the amount listing presentation cancelations and by innovating the agent's listing presentation to secure more listings. The method uses an agent introduction video, an agent promotional magazine, and an agent script for the real estate agent. The agent introduction video is a custom video that serves as a third-party endorsement to the agent. The agent promotional magazine is a custom magazine that illustrates the ability of the real estate agent to sell the property faster and at a higher price by utilizing the innovative technology available to the agent. The agent script is used in conjunction with the agent promotional magazine to illustrate to the potential seller the benefits of choosing the real estate agent to list the property.

The current application claims a priority to the U.S. provisional patent application Ser. No. 63/113,525 filed on Nov. 13, 2020.

### FIELD OF THE INVENTION

The present invention generally relates to real estate systems and methods. More specifically, the present invention involves systems and methods that enable real estate agents to reduce the number of cancellations of scheduled listing presentations and to enable real estate agents to secure a higher percentage of listing presentations.

### BACKGROUND OF THE INVENTION

Within the real estate industry, there are many different systems and methods currently available that enable real estate agents and owners to list and sell different real estate. These systems and methods of listing and selling real estate have endless possibilities in terms of sale effectiveness and profit optimization. However, many of these are very standard and widely applied, making the whole process of listing and selling real estate very similar from one real estate agency to another. This leads to a stagnation in real estate listing and selling which brings many disadvantages to owners who want their real estate assets to stand out in the market in order to sell the assets at a higher price. The stagnation also brings disadvantages to real estate agents who want to secure more listings in a competitive market. For example, real estate agents often have initial appointments with owners canceled as the potential clients lose interest or change their mind before the meeting due to the wide range of real estate agencies available to the owners. So, it is important for real estate agents and owners to stand out in the market by using novel techniques and technologies.

Therefore, an objective of the present invention is to help real estate agents to reduce the number of cancellations of scheduled listing presentations in order to secure a high percentage of listing presentations. The present invention provides a unique system and method that enables real estate agents win more listings and sell more homes by providing real estate owners with a variety of products and technologies that make their real estate stand out even in a competitive market. In addition, the present invention enables real estate owners to earn more profit by selling their assets using the present invention due to the different products and technologies provided. Additional features and benefits of the present invention are further discussed in the sections below.

### SUMMARY OF THE INVENTION

The present invention is a system and a method of optimizing a lead conversion rate for a real estate agent. The present invention, also referred to as the “The Agent Advantage Program” by Hommati, is a cutting-edge strategy designed to help real estate agents to win more listings and sell more homes. Many sellers interview two to three real estate agents before selecting an agent to list their home. How do the real estate owners choose from all available options? It usually comes down to the agent's Unique Selling Proposition (USP). The USP serves as the agent's competitive advantage over the rest of real estate agents. Unfortunately, nearly 90% of agents are using one or more of the same 22 USPs, which have made most listing presentations to become very generic. The present invention enables real estate agents to stand out from the rest of local agents by innovating their USP.

The present invention helps real estate agents to innovate their USP by providing various products and tools that can assist agents in winning up to 25% more of their listing presentations. The different presentation products and tools can include, but are not limited to, a custom agent listing video, a custom innovative agent magazine, among others. The present invention also helps real estate sellers to earn a greater profit by providing various listing products and tools that help the seller's real estate stand out from other properties. These listing products and tools include, but are not limited to, a 3D interactive tour, aerial video and stills, High Definition (HD) photography, Virtual Reality (VR) tour, video slideshows, a floor plan, among others.

### BRIEF DESCRIPTION OF THE DRAWINGS

FIG. 1 is a schematic view of the system of the present invention.

FIG. 2 is a flowchart illustrating the overall process of the method for the present invention.

FIG. 3 is a flowchart illustrating a sub-process for presenting a professional description of a real estate agent, contact information of the real estate agent, and a description of additional listing tools during the agent introduction video.

FIG. 4 is a flowchart illustrating a sub-process for presenting a professional description of a real estate agent and a description of additional listing tools in the agent promotional magazine.

FIG. 5 is a flowchart illustrating a sub-process for presenting the additional listing tools to the potential seller from at least one electronic code inscribed within the agent promotional magazine.

FIG. 6 is a flowchart illustrating a sub-process for presenting a plurality of tiered service packages in the agent promotional magazine.

FIG. 7 is a flowchart illustrating a sub-process for presenting an estimation worksheet in the agent promotional magazine.

### DETAIL DESCRIPTIONS OF THE INVENTION

All illustrations of the drawings are for the purpose of describing selected versions of the present invention and are not intended to limit the scope of the present invention.

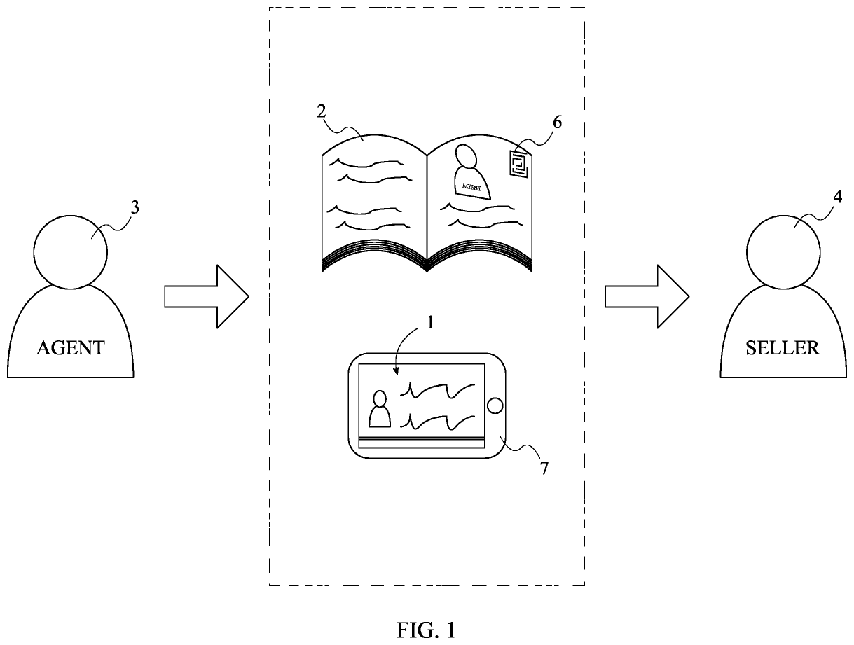

The present invention is a system and method of optimizing a lead conversion rate for a real estate agent. The present invention is used by a real estate agent to secure a higher number of listings by reducing the number of cancelations the real estate agent receives from scheduled listing presentations due to the seller listing with a different agent before the real estate agent has had an opportunity to present and by innovating the listing presentation of the real estate agent to secure more listings. As can be seen in FIG. 1, the preferred embodiment of the system used to implement the method of the present invention is provided with an agent introduction video 1, an agent promotional magazine 2, and an agent script for at least one real estate agent 3 (Step A). The agent introduction video 1, also referred to as the agent listing video, is a custom introductory video that serves as a third-party endorsement to the at least one real estate agent 3. The agent promotional magazine 2 is a custom-printed magazine that illustrates the ability of the real estate agent 3 to sell the property of the potential seller 4 faster and at a higher price by utilizing the innovative technology available to the real estate agent 3. The agent script is used in conjunction with the agent promotional magazine 2 to help the real estate agent 3 to illustrate to the potential seller 4 the benefits of choosing the at least one real estate agent 3 to list the seller's real estate. Further, the at least one real estate agent 3 can be an independent agent, or an agency composed of multiple real estate agents.

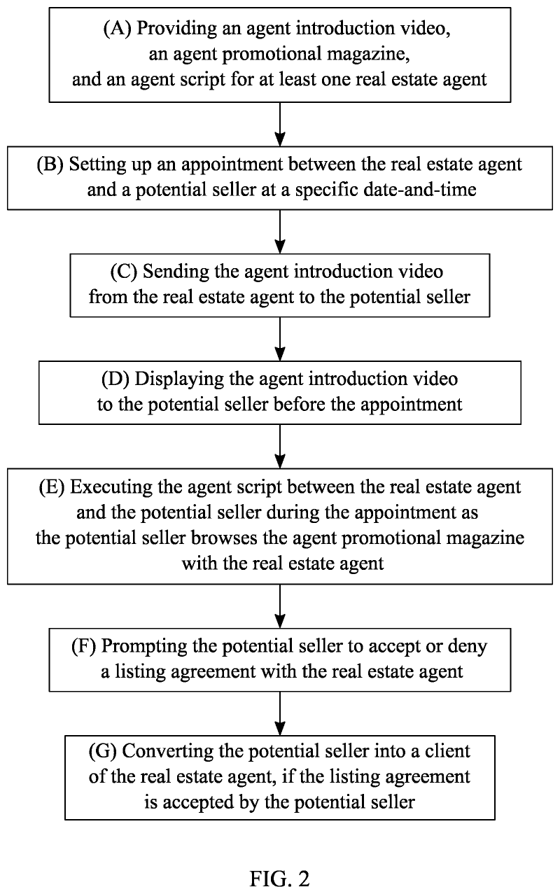

The overall process followed by the method of the present invention allows the aforementioned components of the system to help the real estate agent 3 to reduce the amount of listing presentation cancellations and to successfully secure more listings. As can be seen in FIG. 2, the overall process begins by setting up an appointment between the real estate agent 3 and a potential seller 4 at a specific date-and-time (Step B). The appointment can be set directly between the seller and the real estate agent 3 or through a scheduling service. After the appointment has been set, the real estate agent 3 can prevent a large percentage of those cancelations by sending the agent introduction video 1 to the potential seller 4 (Step C). By sending the agent introduction video 1 prior to the appointment, the real estate agent 3 can minimize the chances of a cancellation for the appointment as the potential seller 4 is encouraged by the agent introduction video 1 to list the seller's real estate with the real estate agent 3. The real estate agent 3 can send the agent introduction video 1 via online communication (email, direct messaging, etc.), through other traditional communication means (text message), or via new file sharing technologies. The agent introduction video 1 is then displayed to the potential seller 4 before the appointment (Step D). Thus, the potential seller 4 is able to watch the agent introduction video 1 before the appointment. By providing the agent introduction video 1 before the appointment, the agent introduction video 1 increases the chances that the potential seller 4 does not prematurely list with a different real estate agent prior to speaking with the real estate agent 3 as one of the choices of the potential seller 4 and does not cancel the appointment.

Continuing the overall process, once the real estate agent 3 and the potential seller 4 meet at the appointment, the agent script is executed between the real estate agent 3 and the potential seller 4 as the potential seller 4 browses the agent promotional magazine 2 with the real estate agent 3 (Step E), as can be seen in FIG. 2. The agent script helps the real estate agent 3 optimize the listing presentation by using the agent promotional magazine 2 to the fullest potential. The agent script enables the real estate agent 3 to fully and clearly explain all the benefits of listing with real estate agent 3 to the potential seller 4, such as selling the real estate faster and at a higher price. After the agent script is fully performed, the potential seller 4 is prompted to accept or deny a listing agreement with the real estate agent 3 (Step F). If the real estate agent 3 fully and correctly performed the agent script using the agent promotional magazine 2, there is a greater chance that the potential seller 4 will accept the listing agreement. If the listing agreement is accepted by the potential seller 4, the potential seller 4 is converted into a client of the real estate agent 3 (Step G). However, if the potential seller 4 denies the listing agreement or postpones the decision, the real estate agent 3 can try to further persuade the potential seller 4 or schedule a follow-up appointment.

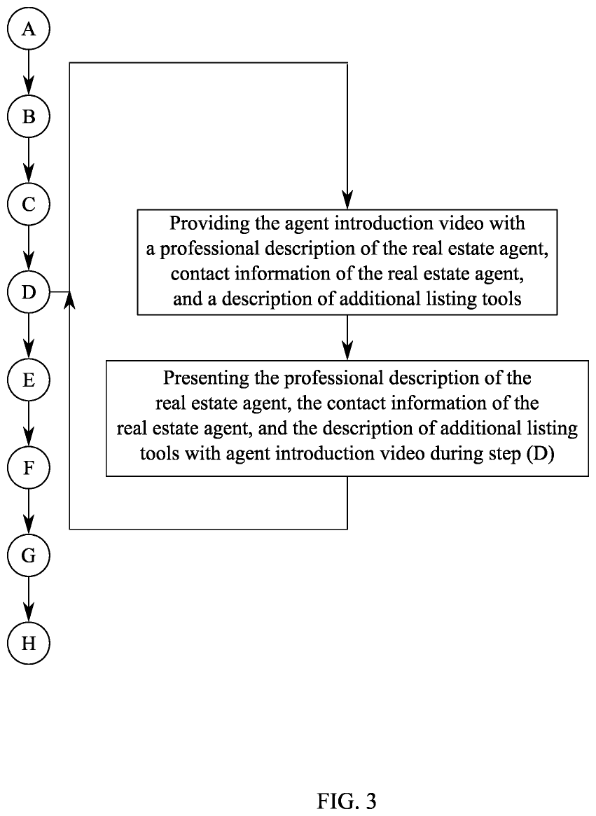

In order to improve the efficiency and the effectiveness of the system, the agent introduction video 1 is customized to serve as an endorsement to the real estate agent 3 from a third party, Hommati, who specializes in dynamic content to help homes sell faster and often for a higher selling price. To do so, the agent introduction video 1 is provided with a professional description of the real estate agent 3, contact information of the real estate agent 3, and a description of additional listing tools, as can be seen in FIG. 3. The professional description of the real estate agent 3 as well as the contact information of the real estate agent 3 serve to increase the credibility of the real estate agent 3. The professional description of the real estate agent 3 may include, but is not limited to, the agent's image, the agent's name, the agent's firm name, or a combination thereof. The description of additional listing tools serves to convince the potential seller 4 that the real estate agent 3 has the best listing tools to sell the real estate of the potential seller 4 at the best price. The description of additional listing tools explains that the additional listing tools include the most innovative technology on the market that increase inquiries by up to 403%, decreasing the time on market by up to 31% and increasing the selling price up to 4-9% higher than listing using only photography to promote the listing. As a subprocess of the overall process, the professional description of the real estate agent 3, the contact information of the real estate agent 3, and the description of additional listing tools are presented with the agent introduction video 1 during Step D. Further, the description of additional listing tools may disclose, but is not limited to, a three-dimensional interactive tour, at least one aerial video, at least one aerial still, at least one high-definition photograph, a virtual reality tour, a video slideshow, a floor plan, or a combination thereof. All these listing tools are used by the real estate agent 3 to successfully attract interested buyers so that the real estate is sold faster.

In addition to the agent introduction video 1, the system of the present invention may be further provided with at least one Augmented-Reality (AR) business card for the real estate agent 3. The potential seller 4 can utilize a compatible computing device to access the media accessible through the at least one AR business card. The at least one AR business card is embedded with identification information that includes an electronic address for a biography video of the real estate agent 3. The at least one AR business card provides the potential seller 4 with another convenient way to access information regarding the real estate agent 3. The at least one AR business card also serves as another way to increase the credibility of the real estate agent 3 and to further entice the potential seller 4 to not cancel the appointment prior to the listing presentation. The potential seller 4 can be further convinced that the real estate agent 3 has the most modern listing tools available to help sell the real estate at a faster pace.

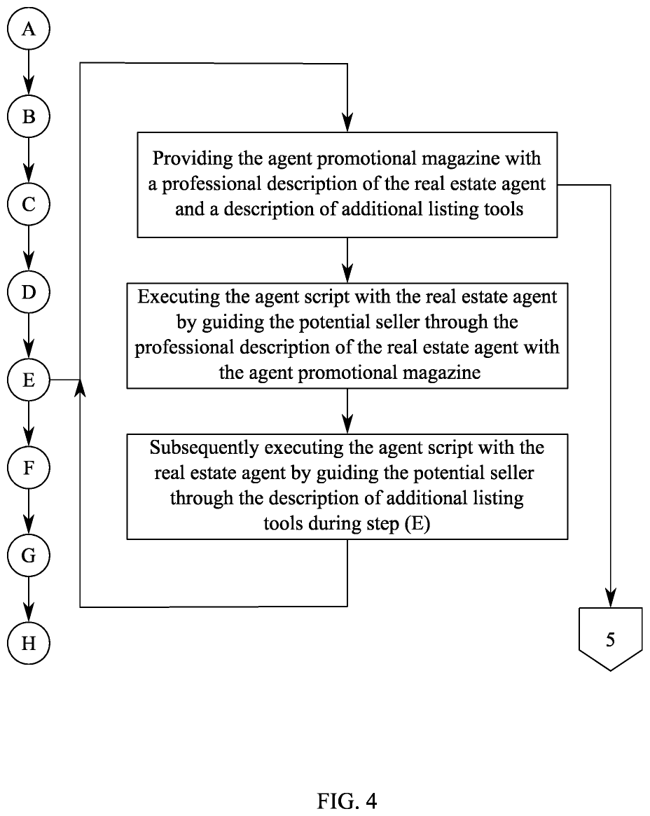

In order to further improve the efficiency and the effectiveness of the system, the agent promotional magazine 2 is customized to also serve as an endorsement to the real estate agent 3 from the same major real estate company. The agent promotional magazine 2 reinforces the innovative technology employed by the real estate agent 3 to sell the real estate of the potential seller 4 up to 31% faster and for a 4% to 9% higher selling price than other agents may achieve by utilizing traditional listing tools. As can be seen in FIG. 4, the agent promotional magazine 2 may be provided with a professional description of the real estate agent 3 and a description of additional listing tools. Like in the agent introduction video 1, the professional description of the real estate agent 3 serves to further increase the credibility of the real estate agent 3. Additional professional descriptions not initially provided in the agent introduction video 1 can be provided in the agent promotional magazine 2. The professional description of the real estate agent 3 may include the agent's picture on the front cover. If the real estate agent 3 is part of an agency, no more than three people can be in the front cover picture. The agent promotional magazine 2 may also include a high-resolution image of the logo of the real estate agent 3. The description of additional listing tools in the agent introduction video 1 provides additional information regarding the different listing tools to further convince the potential seller 4 that the real estate agent 3 has the best listing tools to sell the real estate of the potential seller 4 at the best price. As a subprocess of the overall process, to start the listing presentation, the agent script is initially executed with the real estate agent 3 by guiding the potential seller 4 through the professional description of the real estate agent 3 with the agent promotional magazine 2. Subsequently, the agent script is executed with the real estate agent 3 by guiding the potential seller 4 through the description of additional listing tools during Step E. Furthermore, similar to the agent introduction video 1, the description of additional listing tools in the agent promotional magazine 2 may disclose, but is not limited to, a three-dimensional interactive tour, at least one aerial video, at least one aerial still, at least one high-definition photograph, a virtual reality tour, a video slideshow, a floor plan, or a combination thereof. All these listing tools help convince the potential seller 4 that the real estate agent 3 is prepared to sell the real estate faster and at a higher price.

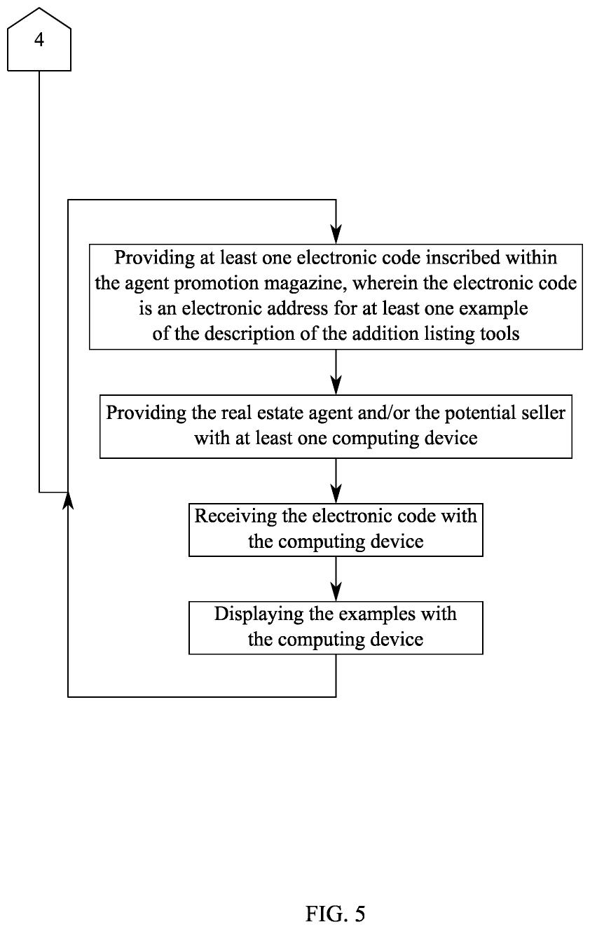

The system of the present invention may further be provided with at least one electronic code 6 inscribed within the agent promotion magazine, as can be seen in FIG. 5. The at least one electronic code 6 enables the real estate agent 3 or the potential seller 4 with a quick method to access examples of the additional listing tools on a software application, such as a website or computer application. The electronic code 6 is preferably an electronic address for at least one example of the description of the addition listing tools. For example, the at least one electronic code 6 can be Quick Response (QR) code or similar graphical codes that can be printed on the agent promotional magazine 2. As a subprocess of the overall process, while the real estate agent 3 is executing the agent script, the real estate agent 3 and/or the potential seller 4 can activate the at least one computing device 7 to receive the electronic code 6 with the computing device 7. Then, the examples of the additional listing tools are displayed with the computing device 7, which gives the potential seller 4 a better idea of the advantages of listing with the real estate agent 3.

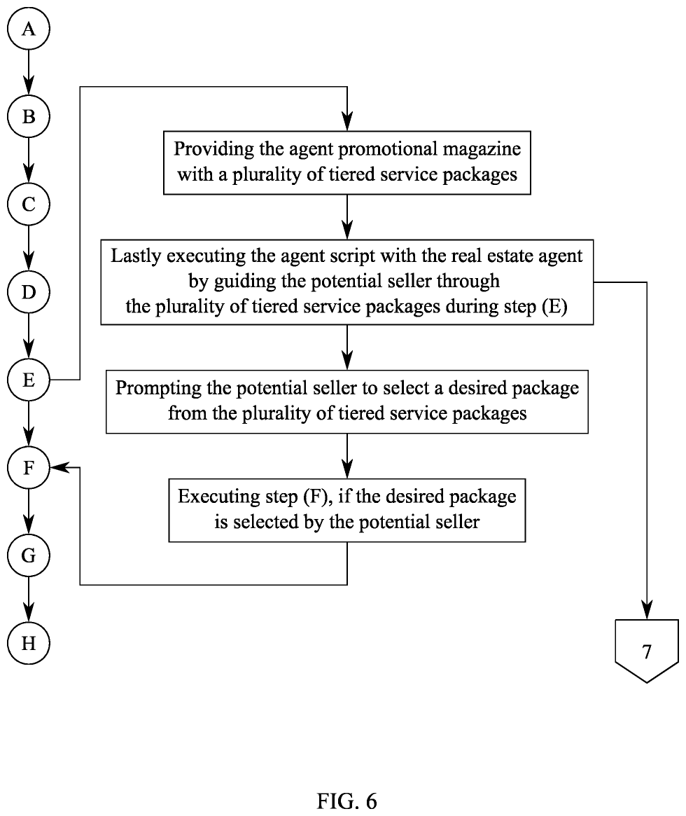

To help the real estate agent 3 close the listing presentation, the system of the present invention may further provide the agent promotional magazine 2 with a plurality of tiered service packages, as can be seen in FIG. 6. The plurality of tiered service packages provides the potential seller 4 with options that cater to different needs of the potential seller 4 at different prices. The plurality of tiered service packages can include different bundles of listing tools that help the real estate agent 3 to sell the real estate faster and at a higher price. As a subprocess of the overall process, the agent script is lastly executed with the real estate agent 3 by guiding the potential seller 4 through the plurality of tiered service packages during Step E. Then, the potential seller 4 is prompted to select a desired package from the plurality of tiered service packages. Afterwards, Step F is executed if the desired package is selected by the potential seller 4.

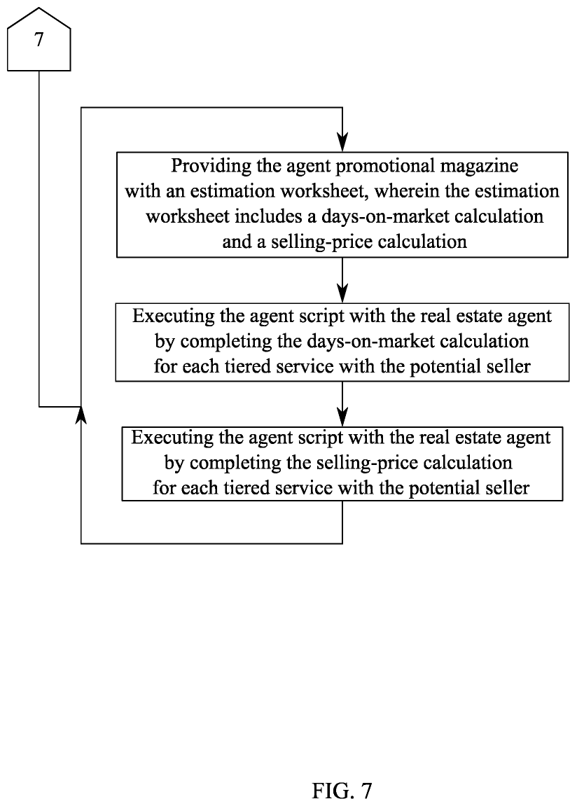

To help the real estate agent 3 encourage the potential seller 4 to select a specific package of the plurality of tiered service packages, the system of the present invention may further provide the agent promotional magazine 2 with an estimation worksheet, as can be seen in FIG. 7. The estimation worksheet helps the real estate agent 3 give an idea to the potential seller 4 of the potential profit that can be earned by selecting the recommended specific package of the plurality of tiered service packages. By quantifying how much faster the real estate agent 3 can sell the real estate and how much more the real estate can be sold for using the listing tools of the present invention, the real estate agent 3 has a stronger USP. The estimation worksheet preferably includes a days-on-market calculation and a selling-price calculation. The days-on-market calculation illustrates how much less the real estate of the potential seller 4 can stay on the market by selecting the recommended specific package. The selling-price calculation illustrates how much more the real estate can be sold for by selecting the recommended specific package. As a subprocess of the overall process, the agent script is executed with the real estate agent 3 by completing the days-on-market calculation for each tiered service with the potential seller 4. Then, the agent script is executed with the real estate agent 3 by completing the selling-price calculation for each tiered service with the potential seller 4.

### Exemplary Embodiment of the Agent Script and the Estimation Worksheet:

The following exemplary embodiment of the agent script is utilized in conjunction with the agent promotional magazine 2 during Step E through Step G, as can be seen in FIG. 2 through 7. The real estate agent 3 follows along the agent script and points things out in the agent promotional magazine 2 as the real estate agent 3 talks with the potential seller 4. A large portion of the agent script is nearly word-for-word with some of the text shown in the agent promotional magazine 2 so that the agent script is not difficult to learn and incorporate into the listing presentation.

The real estate agent 3 approaches the potential seller 4 with the agent promotional magazine 2. While holding the front cover of the agent promotional magazine 2, the real estate agent 3 says:
As part of my overall marketing strategy, I have partnered with Hommati who provides services that will help your home sell faster and for the best price with the least amount of inconvenience to you.
   The agent then presents the front cover of the magazine and point to the Hommati logo and says:
Unlike most agents that may just use photographs to market a home, I utilize the most cutting-edge technology that can . . .
   The real estate agent 3 slides their finger down to just below the title Dynamic Visual Content and follows with the statement:
. . . increase inquiries by over 403%, help sell your home up to 31% faster and increase your sales price by up to 4-9%.
   Next, the real estate agent 3 opens and presents the agent promotional magazine 2 to the second page, inside the front cover, and points to the top image followed by saying:
As I'm sure you are aware 93% of all buyers use the internet to search for homes. Since there are millions of homes for sale at any given time, we need a way to make your home stand out. That's where Hommati comes in.
   The real agent follows by presenting the third page of the agent promotional magazine 2, points to the top of the page, and continues by saying:
Buyers are interested in images and videos of homes. They don't want to read about a home's features, they actually want to see them. We capture the buyer's attention with drone video and photography.
   The real estate agent 3 then scrolls down towards the bottom of the page and while pointing to the text under the drone say:
Homes listed with video get four times the inquiries of homes listed without video.
   At this point, the real estate agent 3 uses the computing device 7, such as a smartphone, to scan the electronic code 6 on the page. The real estate agent 3 then says:
Let me show you a sample of an aerial video.
   When the real estate agent 3 scans the electronic code 6, such as a Quick Response (QR) code, the sample listing will open on the computing device 7 and go to an overview page of a sample listing. After reaching the overview page, the real estate agent 3 navigates to an aerial video tab that plays a sample aerial video to the potential seller 4. Once the potential seller 4 has finished watching the sample aerial video, the real estate agent 3 goes back to the agent promotional magazine 2 and opens to the page with the text “Technology has completely transformed the online . . . ” The real estate agent 3 then follows with:
Technology is completely transforming the ways buyers search for homes today.
   The real estate agent 3 then points to a dollhouse view and say:
I use 3D virtual tours for all my listings, which allows buyers to ‘walk through’ your home online so they get a perfect feel for what your home looks like and its layout.
   After the said statement, the real estate agent 3 navigates back to computing device 7 and brings back the sample listing. The real estate agent 3 then navigates to a 3D tab and plays the sample 3D tour. The real estate agent 3 is to navigate and show the potential seller 4 sample 3D tour while explaining to the potential seller 4 that the real estate agent 3 will create a fully immersive 3D or VR tour as some buyers who have access VR headsets can navigate the VR tour as well using said VR headsets. While the real estate agent 3 is walking through the sample 3D tour, the real estate agent 3 explains:
They can go from room to room, walk up and down the stairs, they can look up and see the ceiling fixtures, look down and see the flooring in each room and they can even walk up to each window and check out the view.
That way, when they request a showing, they are coming in to validate what they saw online, not to understand how your layout works. When we schedule a showing, you'll know that the people coming into your home are “pre-qualified” and excited. You're not just another house on their list. So, you are not cleaning your house and getting it ready for a dozen showings when there may only be one possible buyer out of all those less qualified buyers.
   Next, the real estate agent 3 goes back to the agent promotional magazine 2 and points to the page with the text “Statistics from real estate websites . . . ” and follows by explaining:
Statistics from real estate websites show that listings in 3D virtual tours get clicked on 40% more than listings without 3D virtual tours.
   Next, the real estate agent 3 goes to the page with the text “Home promotion with Hommati's Platinum Package . . . ” and says:
When I promote your home with Hommati's Platinum Package, we can increase inquiries by 403%, close up to 31% faster and net as much as 9% higher on a selling price.
   Soon after the said statement, the real estate agent 3 reads at least six bullet points of the platinum package. The platinum package is the recommended package of the plurality of tiered service packages. By recommending the platinum package, the potential seller 4 is confident that the real estate agent 3 is providing the best experience possible. The agent continues by saying:
The Platinum Package is the full suite of services that Hommati offers. It includes the 3D Virtual Tour, Aerial Video & Aerial Stills, 2D Ultra High-Definition Photography, Virtual Reality Tour, Video Slideshow, Floor plan and brochure. Your listing will be featured in Hommati.com and will be syndicated to hundreds of other real estate related websites. If you list with me, I am willing to make the investment out of my own pocket and purchase the platinum package for you.
   Soon after, the real estate agent 3 marks the platinum package as the chosen package from the plurality of tiered service packages and navigates to the estimation worksheet.

The real estate agent 3 starts working on the estimation worksheet by first performing the days-on-market calculation. The days-on-market calculation is used to give an estimation of how much faster the real estate agent 3 may be able to sell the property of the potential seller 4 by using the platinum package. For the days-on-market calculation, the real estate agent 3 takes the average number of days homes are on the market in the area based on the price range, size, and type of property. Then, the average number of days is multiplied by 0.31 and recorded on the space provided on the estimation worksheet. For example, if the property would normally sell in 90 days, then the real estate agent 3 multiplies 90 days by 0.31, which results in 28 days. This means that the property would be sold in 28 days sooner. If the property is more expensive, or there is something unique about the property that increases or decreases the average time on the market, the real estate agent 3 and the potential seller 4 would adjust the figures accordingly. For example, if the property is four times the average market value (i.e., over $1,000,000) and the property would normally take 8 months to sell, then the days-on-market calculation would calculate 240 days times 0.31 which equals to 74 days. The real estate agent 3 would record on the estimation worksheet that the property may sell in 74 days sooner.

Then, the real estate agent 3 process to work on the selling-price calculation. The selling-price calculation is used to estimate how much more the real estate agent 3 may be able to get for the selling price of the property comparatively to other real estate agents only using photography on the listing. For the selling-price calculation, the real estate agent 3 and the potential seller 4 need to choose a percentage of increase for the property. More expensive properties are likely to have a smaller increase than lower priced properties. In addition, the current real estate market dictates the actual percentage and pricing. The real estate agent 3 may just decide to use 4% all the time or may decide to calculate both the low and high ranges and record both amounts on the estimation worksheet. For example, if the home value is $250,000, the real estate agent 3 can use 4% to calculate a $10,000 price increase for the selling-price calculation. Alternatively, the real estate agent 3 might use the entire low and high ranges and record a range of $10,000 to $22,500 on the worksheet.

Both the days-on-market calculation and the selling-price calculation state that by listing with the real estate agent 3 the property can spend less time on the market and increase the selling price above what the property might sell for with other agents using photography only for the listing. The estimation worksheet is based on a Texas Tech University study. The estimation worksheet enables the real estate agent 3 to quantify the potential decrease in the estimated days the real estate agent 3 may be able to sell the home for and the potential increase in the estimated dollars the potential seller 4 may net in the sale. Once both calculations have been presented to the potential seller 4 and the results have been recorded on the estimation worksheet, the real estate agent 3 closes the listing presentation by explaining:
There was a study done by Texas Tech University that analyzed over 143,000 listings and they found those that had 3D Tours typically sold faster and for a higher selling price depending upon the market. Since I am committing to invest in the platinum package for your home and it includes the 3D tour, along with all those other services, if you list your home with me, I may be able to sell it up to X days faster and for up to Y dollars more than the other agents who are only using photographs to market their homes. When everything is said and done, that's really all that matters, right? Selling your home as quickly as possible and for the highest possible selling price? I am excited about getting your home sold and as my presentation shows, I am ready. I have all the skills and knowledge, the experience, and the energy to get your home sold. Combining that with the strategies and innovative tools that I invest in, I hope you'll agree that I am the agent that will get your home sold the fastest and for the best price. Please put me to work, I'm ready to go.

The agent then proceeds to start filling out the listing agreement. If the real estate agent 3 has a favorite closing statement, the real estate agent 3 has the option to use that closing statement instead of the one provided above. Regardless, the real estate agent 3 must end the closing statement with the phrase:
. . . with the strategies and innovative tools that I invest in, I hope you will agree that I am the agent that will get your home sold the fastest and for the best price.

If the real estate agent 3 fails to secure the listing the day of the listing presentation, it is important that the real estate agent 3 leaves the agent promotional magazine 2 with the recommended package marked and the estimation worksheet filled out for the potential seller 4. This is part of the overall marketing material of the real estate agent 3 that is left behind for the potential seller 4. This benefits the real estate agent 3 in such a way that if the potential seller 4 looks at other options, the potential seller 4 will remember that the real estate agent 3 is using all the innovative technology that helps sell the property of the potential seller 4 faster and potentially at a higher selling price.

In another embodiments, the method of present invention can be implemented as a software application that is being executed through a network of computing devices. The network of computing devices may include a first personal computing device for the real estate agent 3, a server working as the main hub of the network, and a second personal computing device for the potential seller 4. The real estate agent 3 may contact the potential seller 4 via the network of computing devices, where media can be shared between the real estate agent 3 and the potential seller 4. Then, the Steps A through G can be performed via the network as the real estate agent 3 interacts on the first personal computing device and the potential seller 4 interacts on the second personal computing device. Furthermore, the network may provide an interactive platform on which the potential seller 4 can be shown the listings tools offered by the real estate agent 3.

Although the invention has been explained in relation to its preferred embodiment, it is to be understood that many other possible modifications and variations can be made without departing from the spirit and scope of the invention.

What is claimed is:

1. A method of optimizing a lead conversion rate for a real estate agent, the method comprising the steps of: providing an agent introduction video and an agent promotional magazine for at least one real estate agent; setting up an appointment between the real estate agent and a potential seller; sending the agent introduction video from the real estate agent to the potential seller; displaying the agent introduction video to the potential seller before the appointment; browsing the agent promotional magazine with the potential seller during the appointment; and prompting the potential seller to accept or deny a listing agreement with the real estate agent.

2. A method of optimizing a lead conversion rate for a real estate agent, the method comprising the steps of:
(A) providing an agent introduction video, an agent promotional magazine, and an agent script for at least one real estate agent;
(B) setting up an appointment between the real estate agent and a potential seller at a specific date-and-time;
(C) sending the agent introduction video from the real estate agent to the potential seller;
(D) displaying the agent introduction video to the potential seller before the appointment;
(E) executing the agent script between the real estate agent and the potential seller during the appointment as the potential seller browses the agent promotional magazine with the real estate agent;
(F) prompting the potential seller to accept or deny a listing agreement with the real estate agent; and,
(G) converting the potential seller into a client of the real estate agent, if the listing agreement is accepted by the potential seller.

3. The method as claimed in claim 2 comprising the steps of:
providing the agent introduction video with a professional description of the real estate agent, contact information of the real estate agent, and a description of additional listing tools; and,
presenting the professional description of the real estate agent, the contact information of the real estate agent, and the description of additional listing tools with agent introduction video during step (D).

4. The method as claimed in claim 3, wherein the description of additional listing tools discloses a three-dimensional interactive tour, at least one aerial video, at least one aerial still, at least one high-definition photograph, a virtual reality tour, a video slideshow, and a floor plan.

5. The method as claimed in claim 2 comprising the steps of:
providing the agent promotional magazine with a professional description of the real estate agent and a description of additional listing tools;
initially executing the agent script with the real estate agent by guiding the potential seller through the professional description of the real estate agent with the agent promotional magazine; and,
subsequently executing the agent script with the real estate agent by guiding the potential seller through the description of additional listing tools during step (E).

6. The method as claimed in claim 5, wherein the description of additional listing tools discloses a three-dimensional interactive tour, at least one aerial video, at least one aerial still, at least one high-definition photograph, a virtual reality tour, a video slideshow, and a floor plan.

7. The method as claimed in claim 5 comprising the steps of:
providing at least one electronic code inscribed within the agent promotion magazine, wherein the electronic code is an electronic address for at least one example of the description of the addition listing tools;
providing the real estate agent and/or the potential seller with at least one computing device;
receiving the electronic code with the computing device; and,
displaying the example with the computing device.

8. The method as claimed in claim 2 comprising the steps of:
providing the agent promotional magazine with a plurality of tiered service packages;
lastly executing the agent script with the real estate agent by guiding the potential seller through the plurality of tiered service packages during step (E);
prompting the potential seller to select a desired package from the plurality of tiered service packages; and,
executing step (F), if the desired package is selected by the potential seller.

9. The method as claimed in claim 8 comprising the steps of:
providing the agent promotional magazine with an estimation worksheet, wherein the estimation worksheet includes a days-on-market calculation and a selling-price calculation;
executing the agent script with the real estate agent by completing the days-on-market calculation for each tiered service with the potential seller; and,
executing the agent script with the real estate agent by completing the selling-price calculation for each tiered service with the potential seller.

10. A method of optimizing a lead conversion rate for a real estate agent, the method comprising the steps of:
(A) providing an agent introduction video, an agent promotional magazine, and an agent script for at least one real estate agent, wherein the agent introduction video includes a professional description of the real estate agent, contact information of the real estate agent, and a description of additional listing tools;
(B) setting up an appointment between the real estate agent and a potential seller at a specific date-and-time;
(C) sending the agent introduction video from the real estate agent to the potential seller;
(D) displaying the agent introduction video to the potential seller before the appointment, and presenting the professional description of the real estate agent, the contact information of the real estate agent, and the description of additional listing tools with agent introduction video;
(E) executing the agent script between the real estate agent and the potential seller during the appointment as the potential seller browses the agent promotional magazine with the real estate agent;
(F) prompting the potential seller to accept or deny a listing agreement with the real estate agent; and,
(G) converting the potential seller into a client of the real estate agent, if the listing agreement is accepted by the potential seller.

11. The method as claimed in claim 10, wherein the description of additional listing tools discloses a three-dimensional interactive tour, at least one aerial video, at least one aerial still, at least one high-definition photograph, a virtual reality tour, a video slideshow, and a floor plan.

12. The method as claimed in claim 10 comprising the steps of:
providing the agent promotional magazine with a professional description of the real estate agent and a description of additional listing tools;
initially executing the agent script with the real estate agent by guiding the potential seller through the professional description of the real estate agent with the agent promotional magazine; and,
subsequently executing the agent script with the real estate agent by guiding the potential seller through the description of additional listing tools during step (E).

13. The method as claimed in claim 12, wherein the description of additional listing tools discloses a three-dimensional interactive tour, at least one aerial video, at least one aerial still, at least one high-definition photograph, a virtual reality tour, a video slideshow, and a floor plan.

14. The method as claimed in claim 12 comprising the steps of:
providing at least one electronic code inscribed within the agent promotion magazine, wherein the electronic code is an electronic address for at least one example of the description of the addition listing tools;
providing the real estate agent and/or the potential seller with at least one computing device;
receiving the electronic code with the computing device; and,
displaying the examples with the computing device.

15. The method as claimed in claim 10 comprising the steps of:
providing the agent promotional magazine with a plurality of tiered service packages;
lastly executing the agent script with the real estate agent by guiding the potential seller through the plurality of tiered service packages during step (E);
prompting the potential seller to select a desired package from the plurality of tiered service packages; and,
executing step (F), if the desired package is selected by the potential seller.

16. The method as claimed in claim 15 comprising the steps of:
providing the agent promotional magazine with an estimation worksheet, wherein the estimation worksheet includes a days-on-market calculation and a selling-price calculation;
executing the agent script with the real estate agent by completing the days-on-market calculation for each tiered service with the potential seller; and,
executing the agent script with the real estate agent by completing the selling-price calculation for each tiered service with the potential seller.
